(19) United States
(12) Patent Application Publication
(10) Pub. No.: US 2023/0375252 A1
(43) Pub. Date: Nov. 23, 2023

(54) CASE ASSEMBLY AND REFRIGERATION DEVICE

(71) Applicants: GUANGDONG MIDEA WHITE HOME APPLIANCE TECHNOLOGY INNOVATION CENTER CO. LTD., FOSHAN (CN); HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Lei ZHONG, FOSHAN (CN); Guo ZENG, FOSHAN (CN); Xuekang LIU, FOSHAN (CN)

(21) Appl. No.: 18/366,622

(22) Filed: Aug. 7, 2023

Related U.S. Application Data
(63) Continuation-in-part of application No. PCT/CN2022/074401, filed on Jan. 27, 2022.

(30) Foreign Application Priority Data
Feb. 9, 2021 (CN) 202110179364.0
Apr. 22, 2021 (CN) 202110437122.7
Apr. 22, 2021 (CN) 202110437127.X
Apr. 22, 2021 (CN) 202110438285.7
Apr. 22, 2021 (CN) 202110438302.7
Apr. 22, 2021 (CN) 202110438309.9
Apr. 22, 2021 (CN) 202110438317.3
Apr. 22, 2021 (CN) 202120844080.4
Apr. 22, 2021 (CN) 202120844122.4
Apr. 22, 2021 (CN) 202120844123.9
Apr. 22, 2021 (CN) 202120844146.X
Apr. 22, 2021 (CN) 202120844287.1

(51) Int. Cl. F25D 23/02

(52) U.S. Cl. CPC F25D 23/028

(57) ABSTRACT

Disclosed are a case assembly and a refrigeration device. The case assembly includes a case, a door, and a hinge assembly; the door has an outer edge and an inner edge; during the door moves from a closed state to a first opening angle, the outer edge moves toward a first reference plane along a first outer-edge trajectory, and the inner edge moves toward a second reference plane along a first inner-edge trajectory; the first outer-edge trajectory has a radius of curvature greater than or equal to 5t, and a distance exceeding the second reference plane is less than or equal to a first predetermined distance; the first inner-edge trajectory has a radius of curvature greater than or equal to 100t, and a distance exceeding the first reference plane is less than or equal to a second predetermined distance; t is a thickness of the door.

### CROSS-REFERENCES TO RELATED APPLICATIONS

The present application is a continuation-in-part application of International (PCT) Patent Application No. PCT/CN2022/074401, filed on Jan. 27, 2022, which claims priority of Chinese Patent Application No. 202110179364.0 filed on Feb. 9, 2021; priority of Chinese Patent Application No. 202110438317.3 filed on Apr. 22, 2021; and the priority of Chinese Patent Application No. 202110437122.7 filed on Apr. 22, 2021; priority of Chinese patent application No. 202120844123.9 filed on Apr. 22, 2021; priority of Chinese Patent Application No. 202110438302.7 filed on Apr. 22, 2021; priority of Chinese Patent Application No. 20212084414.6X filed on Apr. 22, 2021; priority of Chinese Patent Application No. 202110438309.9 filed on Apr. 22, 2021; priority of Chinese Patent Application No. 202120844287.1 filed on Apr. 22, 2021; priority of Chinese Patent Application No. 202110437217.X filed on Apr. 22, 2021; priority of Chinese Patent Application No. 202120844080.4 filed on Apr. 22, 2021; priority of Chinese Patent Application No. 202110438285.7 filed on Apr. 22, 2021; and priority of Chinese Patent Application No. 202120844122.4 filed on Apr. 22, 2021, the entire contents of which are hereby incorporated by reference in its entirety.

### FIELD

The present disclosure relates to a case assembly and a refrigeration device.

### BACKGROUND

For a case assembly including a door and a case, when the door is opened relative to the case, the door may cause compression upon the case, and there may be a situation where the door extends beyond a side of the case assembly, which may lead to problems of damage to the case and problems of interference for an installation environment of the case assembly. For example, for recessed installations, a portion of the door that extends beyond the side of the case assembly may interfere with an embedding wall.

### SUMMARY

The present disclosure provides a case assembly and a refrigeration device.

A case assembly, including: a case, defining a holding space; wherein the holding space has an opening; a door, configured to block the opening; and a hinge assembly, arranged on a pivot side of the case and pivotally connected to the door and the case; wherein the door has an outer edge and an inner edge on the pivot side; a first reference plane and a second reference plane are defined for the door; the first reference plane is parallel to a plane where the opening is located, and a contour of the inner edge is located on the first reference plane in a closed state; the second reference plane is perpendicular to the plane where the opening is located, and a contour of the outer edge is located on the second reference plane in the closed state; the first reference plane and the second reference plane remain stationary with respect to the case during a process of the door being opened relative to the case; during a process of the door, under an action of the hinge assembly, moving from the closed state to an opened state at a first opening angle relative to the case, the outer edge moves toward the first reference plane along a first outer-edge trajectory; the first outer-edge trajectory has a radius of curvature greater than or equal to 5t, and a distance of the first outer-edge trajectory exceeding a side of the second reference plane back to the opening is less than or equal to a first predetermined distance; during a process of the door, under the action of the hinge assembly, moving from the opened state at the first opening angle to an opened state at a second opening angle relative to the case, the outer edge moves along a second outer-edge trajectory toward the first reference plane; the second outer-edge trajectory has a radius of curvature greater than or equal to 5t, and a distance of the second outer-edge trajectory exceeding the side of the second reference plane back to the opening is less than or equal to the first predetermined distance; wherein the t is a thickness of the door; during a process of the door, under the action of the hinge assembly, moving from the opened state at the second opening angle to an opened state at a third opening angle relative to the case, the outer edge moves along a third outer-edge trajectory toward a side of the second reference plane toward the opening; the third outer-edge trajectory is an arc having a radius of curvature of 0.45t-0.55t; a circle center of the third outer-edge trajectory is located in the door.

A case assembly, including: a case, defining a holding space; wherein the holding space has an opening; a door, configured to block the opening; and a hinge assembly, arranged on a pivot side of the case and pivotally connected to the door and the case; wherein the door has an outer edge and an inner edge on the pivot side; in condition of the door being in a closed state relative to the case, the inner edge is closer to the case compared to the outer edge; a first reference plane and a second reference plane are defined for the door; the first reference plane is parallel to a plane where the opening is located, and a contour of the inner edge is located on the first reference plane in the closed state; the second reference plane is perpendicular to the plane where the opening is located, and a contour of the outer edge is located on the second reference plane in the closed state; during a process of the door, under an action of the hinge assembly, moving from the closed state to an opened state at a first opening angle relative to the case, the outer edge moves toward the first reference plane along a first outer-edge trajectory, and the inner edge moves toward a side of the second reference plane toward the opening along a first inner-edge trajectory; wherein the first outer-edge trajectory has a radius of curvature greater than or equal to 5t, and a distance of the first outer-edge trajectory exceeding a side of the second reference plane back to the opening is less than or equal to a first predetermined distance; the first inner-edge trajectory has a radius of curvature greater than or equal to 100t, and a distance of the first inner-edge trajectory exceeding a side of the first reference plane toward the opening is less than or equal to a second predetermined distance; wherein the t is a thickness of the door.

A case assembly, including: a case, defining a holding space; wherein the holding space has an opening; a door, configured to block the opening; and a hinge assembly, arranged on a pivot side of the case and pivotally connected to the door and the case; wherein the door has an outer edge and an inner edge on the pivot side; a first reference plane and a second reference plane are defined for the door; the first reference plane is parallel to a plane where the opening is located, and a contour of the inner edge is located on the first reference plane in a closed state; the second reference plane is perpendicular to the plane where the opening is located, and a contour of the outer edge is located on the second reference plane in the closed state; the first reference plane and the second reference plane remain stationary with respect to the case during a process of the door being opened relative to the case; during a process of the door, under an action of the hinge assembly, moving from the closed state to an opened state at a first opening angle relative to the case, the outer edge moves toward the first reference plane along a first outer-edge trajectory; a radius of curvature of at least part of the first outer-edge trajectory is greater than or equal to 5t, and a distance of the first outer-edge trajectory exceeding a side of the second reference plane back to the opening is less than or equal to a first predetermined distance; during a process of the door, under the action of the hinge assembly, moving from the opened state at the first opening angle to an opened state at a second opening angle relative to the case, the outer edge moves along a second outer-edge trajectory toward the first reference plane; a radius of curvature of at least part of the second outer-edge trajectory is greater than or equal to 5t, and a distance of the second outer-edge trajectory exceeding the side of the second reference plane back to the opening is less than or equal to the first predetermined distance; wherein the t is a thickness of the door; during a process of the door, under the action of the hinge assembly, moving from the opened state at the second opening angle to an opened state at a third opening angle relative to the case, the outer edge moves along a third outer-edge trajectory toward a side of the second reference plane toward the opening; the third outer-edge trajectory is an arc having a radius of curvature of 0.45t-0.55t; a circle center of the third outer-edge trajectory is located in the door.

### BRIEF DESCRIPTION OF THE DRAWINGS

In order to more clearly illustrate the technical solutions in the embodiments of the present disclosure, the accompanying drawings to be used in the description of the embodiments will be briefly introduced below, and it will be obvious that the accompanying drawings in the following description are only some of the embodiments of the present disclosure, and other accompanying drawings can be obtained according to these drawings for those skilled in the art without creative labor.

FIG. 1 is a structural schematic view of a case assembly according to a first implementation of the present disclosure.

FIG. 2 is a schematic view of a motion relationship between a door relative to a case in an existed case assembly.

FIG. 3 is a schematic view of a motion trajectory of an edge in the case assembly shown in FIG. 1.

FIG. 4 is a schematic view illustrating an opening angle of a door relative to a case and a motion trajectory of an edge in the case assembly shown in FIG. 1.

FIG. 5 is a schematic view of a motion trajectory of reference points in the case assembly shown in FIG. 1.

FIG. 6 is a schematic view of a selection range of an inner reference point in the case assembly shown in FIG. 1.

FIG. 7 is a schematic view of a selection range of an outer reference point in the case assembly shown in FIG. 1.

FIG. 8 is a schematic view of an angle of a tangent direction of a trajectory of an inner reference point in the case assembly shown in FIG. 1 according to a second implementation of the present disclosure.

FIG. 9 is a schematic view of an angle of a tangent direction of a trajectory of an outer reference point in the case assembly shown in FIG. 1 according to a second implementation of the present disclosure.

FIG. 10 is a schematic view of a motion-instantaneous-center trajectory of a motion instantaneous center of a door in the case assembly shown in FIG. 1 according to a third implementation of the present disclosure.

FIG. 11 is a structural schematic view of a case assembly according to a fourth implementation of the present disclosure.

FIG. 12 is a schematic view of a hinge shaft structure of a hinge assembly in the case assembly shown in FIG. 11.

FIG. 13 is a schematic view of a hinge slot structure of a hinge assembly in the case assembly shown in FIG. 11.

FIG. 14 is a state schematic view of a hinge assembly in the case assembly shown in FIG. 11 when a door is in a closed state relative to a case.

FIG. 15 is a state schematic view of a hinge assembly in the case assembly shown in FIG. 11 when a door is in an opened state relative to a case at a first opening angle.

FIG. 16 is a state schematic view of a hinge assembly in the case assembly shown in FIG. 11 when a door is in an opened state relative to a case at a second opening angle.

FIG. 17 is a state schematic view of a hinge assembly in the case assembly shown in FIG. 11 when a door is in an opened state relative to a case at a third opening angle.

FIG. 18 is a partially enlarged schematic view of a hinge assembly in a case assembly according to the present disclosure when a door is in a closed state.

FIG. 19 is a partially enlarged schematic view of a hinge assembly in a case assembly according to the present disclosure when a door is in an opened state.

### DETAILED DESCRIPTION OF THE DISCLOSURE

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without making creative labor fall within the scope of protection of the present disclosure.

The technical solutions in the embodiments of the present disclosure will be clearly and completely described below in conjunction with the accompanying drawings in the embodiments of the present disclosure. It is to be understood that the specific embodiments described herein are only for the purpose of explaining the present disclosure and are not a limitation of the present disclosure. It is also to be noted that, for ease of description, only parts and not all structures relevant to the present disclosure are shown in the accompanying drawings. Based on the embodiments in the present disclosure, all other embodiments obtained by those skilled in the art without creative labor fall within the scope of the present disclosure.

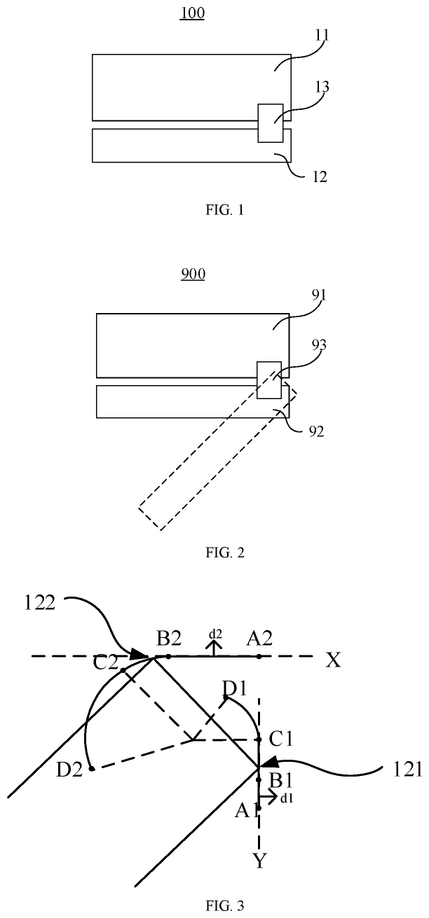

Referring to FIG. 1, FIG. 1 is a structural schematic view of a case assembly according to a first implementation of the present disclosure. The case assembly 100 in the present embodiment includes a case 11, a door 12, and a hinge assembly 13. A holding space is defined inside the case 11, and the holding space has an opening. The door 12 is configured to block the opening. The hinge assembly 13 is arranged on a pivot side of the case 11, and the hinge assembly 13 is pivotally connected to the door 12 and the case 11, such that the door 12 can be opened or closed relative to the case 11 under an action of the hinge assembly 13.

There are various forms of hinge assemblies for realizing a relative rotation of the door and the case, and the setting of the hinge assemblies determines the relative motion relationship between the door and the case. For a case assembly 900 in the related art, referring to FIG. 2, FIG. 2 is a schematic view of a motion relationship between a door relative to a case in an existing case assembly. When the door 92 is opened to a position at a certain angle relative to the case 91, problems of the door 92 compressing the case 91 and the door 92 exceeding a side of the case assembly 900 occur, and the side of the case assembly 900 may be a side of the case 91 or a side of the door 92 in a closed state. It is obvious that the hinge assembly 93 in the related art cannot solve the technical problem of the present disclosure.

The problem of the door compressing the case and exceeding the side of the case assembly is mitigated in the present disclosure by limiting a motion trajectory of an edge on the door. Based on the calculation principle of relative motion, the relative motion relationship between the door and the case may be determined based on a motion trajectory of an edge, thus determining a motion trajectory of a fixed point on the case or door, such that the hinge assembly can be designed inversely based on the motion trajectory of the fixed point. Therefore, the hinge assembly that can realize the motion trajectory of the edge in the present disclosure is within the scope of the present disclosure.

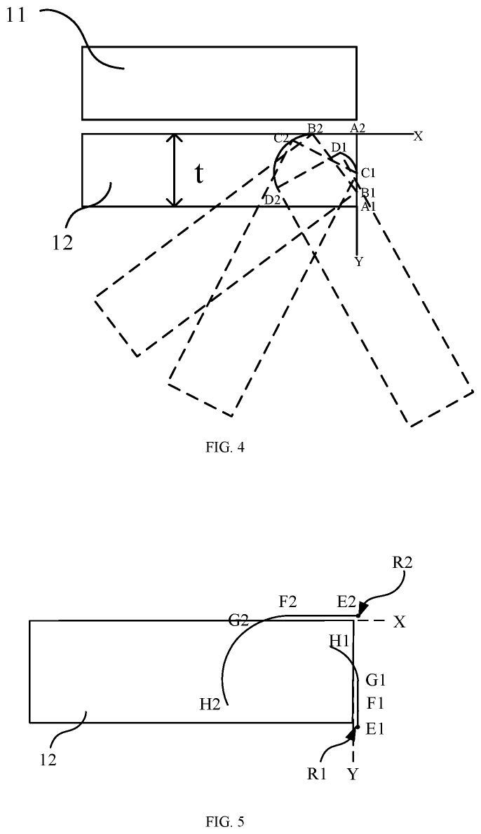

Specifically, referring to FIG. 3 and FIG. 4, FIG. 3 is a schematic view of a motion trajectory of an edge in the case assembly shown in FIG. 1, and FIG. 4 is a schematic view illustrating an opening angle of a door relative to a case and a motion trajectory of an edge in the case assembly shown in FIG. 1.

The door 12 in the present embodiment has an outer edge 121 and an inner edge 122 on the pivot side. When the door 12 is in a closed state relative to the case 11, the inner edge 122 is closer to the case 11 compared to the outer edge 121. A second reference plane Y is defined to be perpendicular to a plane where the opening is located, and a contour of the outer edge 121 is located on the second reference plane Y when in the closed state. A first reference plane X is further defined to be parallel to the plane where the opening is located, and a contour of the inner edge 122 is located on the first reference plane X when in the closed state.

During the process of the door 12, under the action of the hinge assembly 13, moving from the closed state relative to the case 11 to an opened state at a first opening angle (i.e., the door is opened to a position at a first opening angle relative to the case 11), the outer edge 121 moves toward the first reference plane X along a first outer-edge trajectory A1B1, and the inner edge 122 moves toward a side of the second reference plane Y toward the opening along a first inner-edge trajectory A2B2. The first reference plane X and the second reference plane Y do not move along with the door 12 and are fixed reference planes when the door 12 moves. Under the relationship of the door 12 and the case 11 being pivotally connected, the final motion direction of the inner edge 122 relative to the second reference plane Y and the final motion direction of the outer edge 121 relative to the first reference plane X will necessarily be the directions described above during the opening process of the door 12.

Further, for the motions of the outer edge 121 and the inner edge 122 in their respective directions, the first outer-edge trajectory A1B1 has a radius of curvature greater than or equal to 5t and exceeds a side of the second reference plane Y back to the opening by a distance less than or equal to a first predetermined distance d1; the first inner-edge trajectory A2B2 has a radius of curvature greater than or equal to 100t and exceeds a side of the first reference plane X toward the opening by a distance less than or equal to a second predetermined distance d2, where the t is a thickness of the door.

In the present embodiment, the radius of curvature of the motion trajectory and the distance at which the motion trajectory exceeds the reference plane are limited to ensure that the corresponding edge can move smoothly and do not exceed a predetermined range. Among them, a minimum value of the radius of curvature of the first outer-edge trajectory A1B1 and a minimum value of the radius of curvature of the first inner-edge trajectory A2B2 are specifically defined, i.e., when each radius of curvature is selected to be the corresponding minimum value, it can be ensured that the door 12 may not significantly compress the case 11 and that the door 12 may not excessively exceed the side of the case assembly. Moreover, when the radius of curvature is selected to be infinity, the corresponding motion trajectory is a straight line. In the case that each of the two motion trajectories is a straight line, the door 12 may be opened to reach a position at a maximum of 90 degrees relative to the case 11.

When limiting the radiuses of curvature above, taking the thickness t of the door as a reference standard, the radius of curvature of the first outer-edge trajectory A1B1 is greater than or equal to 5t, and the radius of curvature of the first inner-edge trajectory A2B2 is greater than or equal to 100t. This is because the thickness t of the door determines the extent of the door 12 moving relative to the case 11 when the door 12 is being opened. It is obvious that the thicker the door 12 is, the greater the radius of curvature of the motion trajectory is. Specifically, the thickness of the door may be set at least 2 centimeters.

The relevant setting of the first predetermined distance d1 determines the extent to which the outer edge 121 can exceed the side of the case assembly 100. In practice, it is permissible to allow the outer edge 121 to exceed the side of the case assembly 100 by a certain extent. For example, for an embedded use of the case assembly 100, a gap exists between the case 11 and an embedding wall (i.e., a wall in which the case assembly 100 is embedded), and the gap allows the outer edge 121 to exceed the side of the case assembly 100 by a certain extent.

Similarly, the relevant setting of the second predetermined distance d2 determines the extent to which the inner edges 122 can compress the case 11. In practice, it is permissible to allow the inner edge 122 to compress the case 11 to a certain extent. For example, the case 11 is arranged with a deformable door seal, and the compression to a certain extent, applied by the inner edge 121 to the case 11, may be ignored.

Therefore, the specific values of the first predetermined distance and the second predetermined distance may be determined according to the actual product design needs, for example, the first predetermined distance may be determined according to the distance between the wall in which the case assembly is embedded and the case assembly, and the second predetermined distance may be determined according to the thickness or elasticity of the door seal of the case. The thickness of the door is used for scalar purposes in the present embodiment to limit the first predetermined distance and the second predetermined distance to 0 to 0.15 times the thickness of the door. When 0 times is selected, the door is set to not compressing the case and not exceeding the side of the case assembly. In the present embodiment, 0.1 times may be specifically selected, i.e., the door is allowed to exceed the side of the case assembly by 0.1 times the thickness of the door; and the first predetermined distance may be determined to be 0 mm to 4 mm and the second predetermined distance to be 0 mm to 2 mm according to empirical values, and similarly, when 0 mm is selected, the door does not exceed the side of the case assembly. In the present embodiment, the first predetermined distance may be 3 mm and the second predetermined distance may be 1 mm as an example, i.e., the allowed exceeding distances are limited.

Overall, in the present embodiment, during the process of the door 12, under the action of the hinge assembly 13, moving from the closed state relative to the case 11 to the opened state at the first opening angle, the inner edge 122 moves along the first inner-edge trajectory A2B2, and the outer edge 121 moves along the first outer-edge trajectory A1B1. The radius of curvature of the first inner-edge trajectory A2B2 and the first outer-edge trajectory A1B1, and the distance relationship between the trajectories and the second reference plane Y and the first reference plane X are characterized in a certain way, such that the door 12 is moved according to the motion trajectory, so as to attenuate or even avoid the door 12 from compressing the case 11 as well as from exceeding the side of the case assembly 100.

Further, in the present embodiment, an end point B2 of the first inner-edge trajectory A2B2 may be located on the first reference plane X, or the end point B2 may be located on a side of the first reference plane X back to the opening and a distance between the end point B2 and the first reference plane X may be less than or equal to 0.058t; an end point B1 of the first outer-edge trajectory A1B1 may be located on the second reference plane Y, or the end point B1 may be located on the side of the second reference plane Y toward the opening and a distance between the end point B1 and the second reference plane Y may be less than or equal to 0.135t.

That is, after the door 12 is opened at the first opening angle, the inner edge 122 of the door 12 does not compress the case 11 and does not move excessively away from the case 11; while the outer edge 121 does not exceed the side of the case assembly 100 and does not move excessively toward the side of the second reference plane Y toward the opening. The above design allows the door 12 to be opened without significant displacement, and the movement of the door 12 is more stable.

In the present embodiment, when the outer edge 121 moves along the first outer-edge trajectory A1B1 and the inner edge 122 moves along the first inner-edge trajectory A2B2 until the door 12 is opened at 90 degrees, the door 12 may not be able to be further opened at a greater angle.

In order to meet the needs of daily use, a maximum opening angle of the door 12 is generally required to be greater than 90 degrees. Therefore, after the edge of the door 12 move along the first edge trajectory until the door 12 is opened at an angle less than 90 degrees, the edge may move along another motion trajectory such that the door 12 may be further opened at an angle more than 90 degrees. In the case where the door 12 is opened at an angle less than 90 degrees, the first outer-edge trajectory A1B1 is shorter than the first inner-edge trajectory A2B2, and the ratio of the lengths of the first inner-edge trajectory A2B2 and the first outer-edge trajectory A1B1 is 3.5 to 4.5.

As mentioned before, the door 12 may move along a different trajectory after being opened at the first opening angle. In the present embodiment, during the process of the door 12, under the action of the hinge assembly 13, moving from the opened state at the first opening angle to an opened state at a second opening angle relative to the case 11, the outer edge 121 moves along a second outer-edge trajectory B1C1 toward the first reference plane X, while the inner edge 122 moves along a second inner-edge trajectory B2C2 toward the side of the second reference plane Y toward the opening and the side of the first reference plane X back to the opening.

The inner edge 122 starts to move toward the side of the second reference plane Y toward the opening, and a third angle between a tangent direction of the second inner-edge trajectory B2C2 of the inner edge 122 and the first reference plane X gradually increases, and a change in angle of the third angle corresponding to each unit of opening of the door 12 gradually increases. An end point C2 is located on the side of the first reference plane X back to the opening, which allows room for the door 12 to be opened at a greater angle.

In addition, based on the design of the first outer-edge trajectory A1B1, a tangent direction of the second outer-edge trajectory B1C1 is set perpendicular to the first reference plane X, or is set inclined relative to the first reference plane X at a fourth angle of between 70 degrees and 110 degrees.

Based on the above characteristics of the trajectories, during the process of the door 12 moving from the opened state at the first opening angle to the opened state at the second opening angle, the door 12 may not compress the case 11 or excessively exceed the side of the case 11.

Further, during the process of the door 12 moving from the opened state at the first opening angle to the opened state at the second opening angle, the fourth angle may remain unchanged, i.e., the second outer-edge trajectory B1C1 is in a straight line; alternatively, the fourth angle varies monotonically in a straight-line form, and the second outer-edge trajectory B1C1 is in the form of an arc. In this way, the outer edge 121 may move smoothly along the straight-line or the arc-shaped second outer-edge trajectory B1C1.

Moreover, a difference between a maximum value and a minimum value of the fourth angle is less than or equal to 10 degrees, i.e., the second outer-edge trajectory B1C1 is overall gentle, further ensuring smooth movement of the outer edge 121 along the second outer-edge trajectory B1C1.

Similarly, during the process of the door 12 moving from the opened state at the first opening angle to the opened state at the second opening angle, the third angle may gradually increase, i.e., the second inner-edge trajectory B2C2 is in the form of an arc, and the inner edge 122 moves smoothly along the arc-shaped second inner-edge trajectory B2C2. A difference between a maximum value and a minimum value of the third angle is greater than or equal to 35 degrees, i.e., the second inner-edge trajectory B2C2 is overall gentle, further ensuring smooth movement of the inner edge 122 along the second inner-edge trajectory B2C2.

In this way, the process of the door 12 moving from the opened state at the first opening angle to the opened state at the second opening angle is overall smooth, avoiding the situation of sliding jam.

Further, the inner edge 122 starts to move toward the side of the second reference plane Y toward the opening, and the motion trajectory of the inner edge 122 may be in the form of an arc. The radius of curvature of the second inner-edge trajectory B2C2 may gradually decrease. The end point C2 may be located on the side of the first reference plane X back to the opening, and the distance between the end point C2 and the first reference plane may be greater than or equal to 0.3t. The above design allows room for the door 12 to be opened at a greater angle.

In this process, based on the design of the first outer-edge trajectory A1B1, the second outer-edge trajectory B1C1 has a radius of curvature greater than or equal to 5t, and a distance of the second outer-edge trajectory B1C1 exceeding the side of the second reference plane Y back to the opening is less than or equal to the first predetermined distance d1. Based on the above characteristics of the trajectory, during the process of the door 12 moving from the opened state at the first opening angle to the opened state at the second opening angle, the door 12 may not compress the case 11 or excessively exceed the side of the case assembly.

According to the above characteristics of the trajectories, the second outer-edge trajectory B1C1 is a continuation of the first outer-edge trajectory A1B1, while the second inner-edge trajectory B2C2 is an arc with a gradually decreasing radius of curvature set up in order to facilitate the subsequent opening at a greater angle and in order to make the opening of the door smoother.

Similarly, based on the first trajectories and the second trajectories, i.e., considering A1C1 and A2C2 as a whole, the present disclosure further proposes the following scheme: during the process of the door 12 moving from the opened state at the first opening angle to the opened state at the second opening angle relative to the case 11, the inner edge 122 moves along the second inner-edge trajectory B2C2 toward the side of the second reference plane Y toward the opening and the side of the first reference plane X back to the opening, and the radius of curvature of the second inner-edge trajectory B2C2 gradually decreases; the outer edge 121 moves along the second outer-edge trajectory B1C1 toward the first reference plane X, the radius of curvature of the second outer-edge trajectory is greater than or equal to 5t, and the distance of the second outer-edge trajectory B1C1 exceeding the side of the second reference plane Y back to the opening is less than or equal to the first predetermined distance.

The first opening angle herein may be a closing angle and the second opening angle may be any angle. The second inner-edge trajectory may be A2C2, and the second outer-edge trajectory may be A1C1. The inner edge 122 moves away from the opening of the case along the second inner-edge trajectory, avoiding the door from compressing the case; the radius of curvature of the second outer-edge trajectory of the outer edge 21 is greater than or equal to 5t, and the distance of the second outer-edge trajectory exceeding the side of the second reference plane Y back to the opening is less than or equal to the first predetermined distance. According to the above analysis of the first outer-edge trajectory, the above design may avoid the door from exceeding the side of the case assembly.

In addition, in order to facilitate the subsequent opening of the door at a greater angle by another trajectory, a difference between the first opening angle and the second opening angle may be limited to 25 degrees-60 degrees.

Based on the above two design ideas, under the action of the hinge assembly 13, the door 12 may continue to be opened from the second opening angle to a third opening angle relative to the case 11. During the process of the door 12 moving from the opened state at the second opening angle to an opened state at the third opening angle, the inner edge 122 moves along a third inner-edge trajectory C2D2 toward the side of the first reference plane X back to the opening, and the outer edge 121 moves along a third outer-edge trajectory C1D1 toward the side of the second reference plane Y toward the opening. The motion trajectories correspond to a greater opening angle of the door 12.

The third outer-edge trajectory C1D1 and the third inner-edge trajectory C2D2 may specifically be concentrically disposed arcs, the third inner-edge trajectory C2D2 having a radius of curvature of 0.55t-0.67t, and the third outer-edge trajectory C1D1 having a radius of curvature of 0.45t-0.55t.

After the edges of the door 12 move along the first inner-edge trajectory A2B2 and the first outer-edge trajectory A1B1, in order to realize a greater opening angle of the door, the edges may move directly along the third outer-edge trajectory C1D1 and the third inner-edge trajectory C2D2, respectively, thereby solving the problem of compressing the case 11 and exceeding the side of the case assembly.

However, after designing the hinge assembly 13 based on the first trajectories and the third trajectories, the door 12 may be prone to shaking during the rotation process of the door 12 under the action of the hinge assembly 13. In order to further optimize and solve the problem of shaking, the second trajectories are added between the first trajectories the third trajectories, so as to make the motion process of the door 12 more stable and smoother.

Considering the design of the hinge assembly 13, the ratio of the radius of curvature of the third inner-edge trajectory C2D2 to the radius of curvature of the third outer-edge trajectory C1D1 may be 1.22, which is able to prevent structures on the hinge assembly 13 corresponding to the third trajectories from interfering with each other.

Specifically, each set of the three-section trajectory is designed such that the first trajectory corresponds to the first opening angle of 25 degrees to 31 degrees, the second trajectory corresponds to the second opening angle of 57 degrees to 60 degrees, and the third trajectory corresponds to the third opening angle of 122 degrees to 132 degrees.

The length of the first inner-edge trajectory A2B2 is 0.465t, and the length of the first outer-edge trajectory A1B1 is 0.115t.

The length of the second outer-edge trajectory B1C1 is 0.2285t, and the second inner-edge trajectory B2C2 is set such that a motion distance of the outer edge 121 on the second outer-edge trajectory B1C1 and a rotation angle of the door 12 relative to the case 11 satisfy the following equation.

$$θ1 = \frac{t 1}{t} θ$$

where θ1 is the rotation angle, θ is a preset angle of 100 degrees-113 degrees, and t1 is the motion distance.

A circle center of the third inner-edge trajectory C2D2 is located in the door 12 and the radius of curvature is 0.61t. A circle center of the third outer-edge trajectory C1D1 is located in the door 12 and the radius of curvature is 0.5t. For each of the above two circle centers, a perpendicular distance from the circle center to the first reference plane X is 0.6t, and a perpendicular distance from the circle center to the second reference plane Y is 0.5t.

In carrying out the actual design, taking into account installation deformation and other issues, a reference point may be selected for trajectory design, so as to reserve a tolerance for the edge on the door 12, ensuring that the door 12 is avoided from compressing the case 11 and from exceeding the side of the case assembly 100.

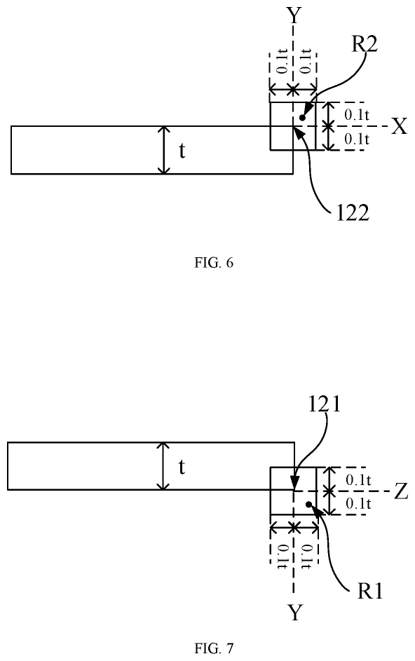

Referring to FIG. 5, FIG. 6, and FIG. 7, FIG. 5 is a schematic view of a motion trajectory of reference points in the case assembly shown in FIG. 1, FIG. 6 is a schematic view of a selection range of an inner reference point in the case assembly shown in FIG. 1, and FIG. 7 is a schematic view of a selection range of an outer reference point in the case assembly shown in FIG. 1.

In the present embodiment, an outer reference point R1 and an inner reference point R2 are defined. The outer reference point R1 is located adjacent to the outer edge 121, and the inner reference point R2 is located adjacent to the inner edge 122. A third reference plane Z is hereby defined, which is parallel to the first reference plane X, and a contour of the outer edge 121 is located on the third reference plane Z when in the closed state.

Specifically, a perpendicular distance from the inner reference point R2 to the second reference plane Y and a perpendicular distance from the inner reference point R2 to the first reference plane X are each less than or equal to 0.1t. The inner reference point R2 is selected in a rectangular region centered on the inner edge 122 with a side length of 0.2t.

Similarly, a perpendicular distance from the outer reference point R1 to the second reference plane Y and a perpendicular distance from the outer reference point R1 to the third reference plane Z are each less than or equal to 0.1t. The outer reference point R1 is selected in a rectangular region centered on the outer edge 121 with a side length of 0.2t.

The outer reference point R1 may be selected on the outer edge 121, and the inner reference point R2 may be selected on the inner edge 122.

The motion trajectory design ideas of the inner reference point R2 and the outer reference point R1 are also based on the above trajectory design ideas of the inner edge 122 and the outer edge 121. During the process of the door 12, under the action of the hinge assembly 13, moving from the closed state relative to the case 11 to an opened state at the first opening angle, the inner reference point R2 moves along a first inner-reference-point trajectory E2F2 toward the side of the second reference plane Y toward the opening, and the outer reference point R1 moves along a first outer-reference-point trajectory E1F1 toward the first reference plane X.

Characteristics of the first inner-reference-point trajectory E2F2 may be all similar to those of the first inner-edge trajectory A2B2, and characteristics of the first outer-reference-point trajectory E1F1 may be all similar to those of the first outer-edge trajectory A1B1, which will not be further described herein.

For ease of design, in the present embodiment, the first inner-reference-point trajectory E2F2 may be a straight line and the first outer-reference-point trajectory E1F1 may be a straight line. Based on a selected position of the inner reference point R2, the first inner-reference-point trajectory E2F2 may be parallel to the first reference plane X or along the first reference plane X; and based on a selected position of the outer reference point R1, the first outer-reference-point trajectory may be parallel to the second reference plane Y or along the second reference plane Y.

Further, the first inner-reference-point trajectory E2F2 may be longer than the first outer-reference-point trajectory E1F1, and the ratio of the lengths of the first inner-reference-point trajectory E2F2 and the first outer-reference-point trajectory E1F1 is 3.5 to 4.5.

Similarly, corresponding to the inner edge 122 and the outer edge 121, both the outer reference point R1 and the inner reference point R2 may each have a second trajectory and a third trajectory. A second inner-reference-point trajectory F2G2 may have characteristics similar to the second inner-edge trajectory B2C2, and a second outer-reference-point trajectory F1G1 may have characteristics similar to the second outer-edge trajectory B1C1; a third inner-reference-point trajectory G2H2 may have characteristics similar to the third inner-edge trajectory C2D2, and a third outer-reference-point trajectory G1H1 may have characteristics similar to the third outer-edge trajectory C1D1.

During the process of the door 12 moving from the opened state at the first opening angle to the opened state at the second opening angle relative to the case 11, the inner reference point R2 moves along the second inner-reference-point trajectory F2G2 toward the side of the second reference plane Y toward the opening and the side of the first reference plane X back to the opening, and the outer reference point R1 moves along the second outer-reference-point trajectory F1G1 toward the first reference plane X.

For ease of design, the second outer-reference-point trajectory F1G1 may be a straight line, and may be along the second reference plane Y or parallel to the second reference plane Y. The second inner-reference-point trajectory F2G2 may be set such that a motion distance of the outer reference point R1 on the second outer-reference-point trajectory F1G1 and a rotation angle of the door 12 satisfy the following equation.

$$θ1 = \frac{t 1}{t} θ$$

where θ1 is the rotation angle, θ is a preset angle of 100 degrees-113 degrees, and t1 is the motion distance.

Further, the present disclosure also mitigates the problems of the door compressing the case and exceeding the side of the case assembly by limiting a tangential direction of the motion trajectory of the edge on the door. The relative motion of the door and the case can be converted into the motion of the tangent direction of the motion trajectory. By designing the tangent direction of the motion trajectory of the edge, the relative motion relationship between the door and the case may be limited, such that the door may not excessively compress the doorway and not excessively exceed the side of the case assembly. Based on above, according to a motion trajectory of the tangent direction of the motion trajectory of the edge, a motion trajectory of a fixed point on the case or the door may be determined, and the hinge assembly may thus be designed by inverse deduction according to the motion trajectory of the fixed point. That is, the hinge assemblies that can realize the motion trajectory of the edge in the present disclosure are within the scope of the present disclosure.

A second implementation is designed from another angle compared with the first implementation, i.e., the tangent direction of the motion trajectory of the edge, and therefore the accompanying drawings and reference numerals in the first implementation are continued to be used. Referring specifically to FIGS. 3 and 4, FIG. 3 is a schematic view of a motion trajectory of an edge in the case assembly shown in FIG. 1, and FIG. 4 is a schematic view illustrating an opening angle of a door relative to a case and a motion trajectory of an edge in the case assembly shown in FIG. 1.

Further, the tangent direction of the first outer-edge trajectory A1B1 is set perpendicular to the first reference plane X, or the tangent direction of the first outer-edge trajectory A1B1 may be set inclined relative to the first reference plane X at a second angle progressively approaching 90 degrees; the tangent direction of the first inner-edge trajectory A2B2 is set along the first reference plane X, or the tangent direction of the first inner-edge trajectory A2B2 is set inclined relative to the first reference plane X at a first angle of less than or equal to 10 degrees.

In the present embodiment, the tangent direction of the motion trajectory is limited, and the ratio of the lengths of the first inner-edge trajectory A2B2 and the first outer-edge trajectory A1BA is also limited, so as to ensure that the edges are able to move smoothly and do not exceed a predetermined range.

Among them, the tangent direction of the first outer-edge trajectory A1B1 is set at the second angle gradually approaching 90 degrees inclined relative to the first reference plane X, ensuring that the door 12 may not significantly compress the case 11. The tangent direction of the first inner-edge trajectory A2B2 is set at the first angle of a maximum value of 10 degrees relative to the first reference plane X, ensuring that the door 12 may not excessively exceed the side of the case 11.

Moreover, when the tangent direction of the first outer-edge trajectory A1B1 is perpendicular to the first reference plane X, and the tangent direction of the first inner-edge trajectory A2B2 is set along the first reference plane X, the two trajectories are straight lines. Corresponding to the case where the two trajectories are both straight lines, the first opening angle may be up to 90 degrees, in which case the first inner-edge trajectory A2B2 is longer than the first outer-edge trajectory A1B1, and the ratio of the lengths of the first inner-edge trajectory A2B2 and the first outer-edge trajectory A1B1 is 3.5-4.5.

The relevant setting of the tangent direction of the first inner-edge trajectory A2B2 determines the extent to which the inner edge 122 can compress the case 11. In practice, it is permissible to allow the inner edge 122 to compress the case 11 to a certain extent. For example, the case 11 is arranged with a deformable door seal, and the compress to a certain extent, applied by the inner edge 122 to the case 11, may be ignored.

Similarly, the relevant setting of the tangent direction of the first outer-edge trajectory A1B1 determines the extent to which the outer edge 121 can exceed the side of the case 11. In practice, it is permissible to allow the outer edge to exceed the side of the case 11 by a certain extent. For example, for an embedded use of the case assembly, a gap exists between the case 11 and an embedding wall, and the gap allows the outer edge 121 to exceed the side of the case 11 by a certain extent.

Further, during the process of the door 12 moving from the closed state to the opened state at the first opening angle, the first angle may remain unchanged, i.e., the first inner-edge trajectory A2B2 is in a straight line; alternatively, the first angle varies monotonically in a straight-line form, and the first inner-edge trajectory A2B2 is in the form of an arc. In this way, the inner edge 122 may move smoothly along the straight-line or the arc-shaped first inner-edge trajectory A2B2.

Moreover, a difference between a maximum value and a minimum value of the first angle is less than 5 degrees, i.e., the first inner-edge trajectory A2B2 is overall gentle, further ensuring smooth movement of the inner edge 122 along the first inner-edge trajectory A2B2.

Similarly, during the process of the door 12 moving from the closed state to the opened state at the first opening angle, the second angle may remain unchanged, i.e., the first outer-edge trajectory A1B1 is in a straight line; alternatively, the second angle gradually approaches 90 degrees, i.e., the first outer-edge trajectory A1B1 is in the form of an arc. In this way, the outer edge 121 may move smoothly along the straight-line or the arc-shaped first outer-edge trajectory A1B1.

In this way, the process of the door 12 moving from the closed state to the opened state at the first opening angle is overall smooth, avoiding the situation of sliding jam.

Further, the inner edge 122 starts to move toward the side of the second reference plane Y toward the opening, and the motion trajectory of the inner edge 122 may be in the form of an arc. The radius of curvature of the second inner-edge trajectory B2C2 may gradually decrease. The end point C2 may be located on the side of the first reference plane X back to the opening, and the distance between the end point C2 and the first reference plane X may be greater than or equal to 0.3t. The above design allows room for the door 12 to be opened at a greater angle.

In this process, based on the design of the first outer-edge trajectory A1B1, the second outer-edge trajectory B1C1 has a radius of curvature greater than or equal to 5t, and a distance of the second outer-edge trajectory B1C1 exceeding the side of the second reference plane Y back to the opening is less than or equal to the first predetermined distance d1.

Based on the characteristics of the above trajectory, during the process of the door 12 moving from the opened state at the first opening angle to the opened state at the second opening angle, the door 12 may not compress the case 11 or excessively exceed the side of the case assembly.

Under the action of the hinge assembly 13, the door 12 may continue to be opened from the second opening angle to the third opening angle relative to the case 11. During the process of the door 12 moving from the opened state at the second opening angle to an opened state at the third opening angle, the inner edge 122 moves along the third inner-edge trajectory C2D2 toward the side of the first reference plane X back to the opening, and the outer edge 121 moves along the third outer-edge trajectory C1D1 toward the side of the second reference plane Y toward the opening. The motion trajectory corresponds to a greater opening angle of the door 12.

The third outer-edge trajectory C1D1 and the third inner-edge trajectory C2D2 may specifically be concentrically disposed arcs, the third inner-edge trajectory C2D2 having a radius of curvature of 0.55t-0.67t, and the third outer-edge trajectory C1D1 having a radius of curvature of 0.45t-0.55t.

After the edges of the door 12 move along the first inner-edge trajectory A2B2 and the first outer-edge trajectory A1B1, in order to realize a greater opening angle of the door, the edges may move directly along the third outer-edge trajectory C1D1 and the third inner-edge trajectory C2D2, respectively, thereby solving the problem of compressing the case 11 and exceeding the side of the case assembly.

However, after designing the hinge assembly 13 based on the first trajectories and the third trajectories, the door 12 may be prone to shaking during the rotation process of the door 12 under the action of the hinge assembly 13. In order to further optimize and solve the problem of shaking, the second trajectories are added between the first trajectories and the third trajectories, so as to make the motion process of the door 12 more stable and smoother.

Considering the design of the hinge assembly 13, the ratio of the radius of curvature of the third inner-edge trajectory C2D2 to the radius of curvature of the third outer-edge trajectory C1D1 may be 1.22, which is able to prevent structures on the hinge assembly 13 corresponding to the third trajectories from interfering with each other.

Specifically, each set of the three-section trajectory is designed such that the first trajectory corresponds to the first opening angle of 25 degrees to 31 degrees, the second trajectory corresponds to the second opening angle of 57 degrees to 60 degrees, and the third trajectory corresponds to the third opening angle of 122 degrees to 132 degrees.

The length of the first inner-edge trajectory A2B2 is 0.465t, and the length of the first outer-edge trajectory A1B1 is 0.115t.

The length of the second outer-edge trajectory B1C1 is 0.2285t, and the second inner-edge trajectory B2C2 is set such that a motion distance of the outer edge 121 on the second outer-edge trajectory B1C1 and a rotation angle of the door 12 relative to the case 11 satisfy the following equation.

$$θ1 = \frac{t 1}{t} θ$$

where θ1 is the rotation angle, θ is a preset angle of 100 degrees-113 degrees, and t1 is the motion distance.

A circle center of the third inner-edge trajectory C2D2 is located in the door 12 and the radius of curvature is 0.61t. A circle center of the third outer-edge trajectory C1D1 is located in the door 12 and the radius of curvature is 0.5t. For each of the above two circle centers, a perpendicular distance from the circle center to the first reference plane X is 0.6t, and a perpendicular distance from the circle center to the second reference plane Y is 0.5t.

In carrying out the actual design, taking into account installation deformation and other issues, a reference point may be selected for trajectory design, so as to reserve a tolerance for the edge on the door 12, ensuring that the door 12 is avoided from compressing the case 11 and from exceeding the side of the case assembly 100.

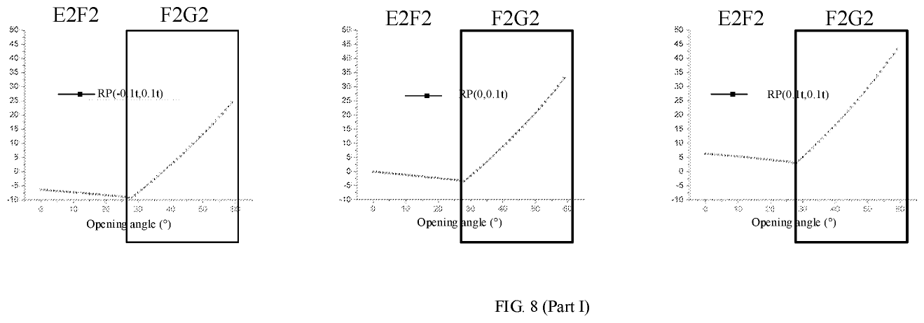

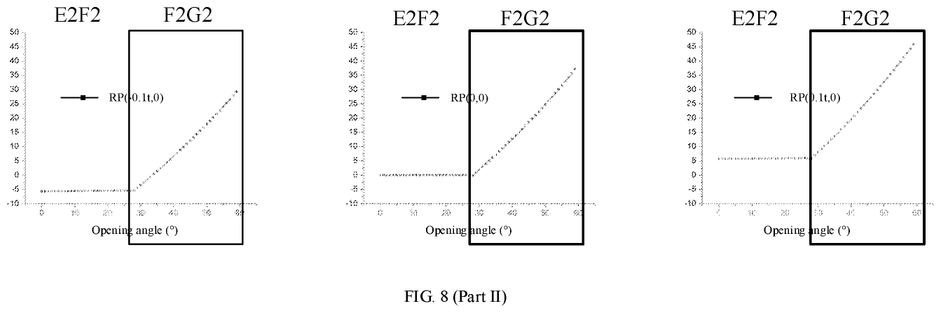

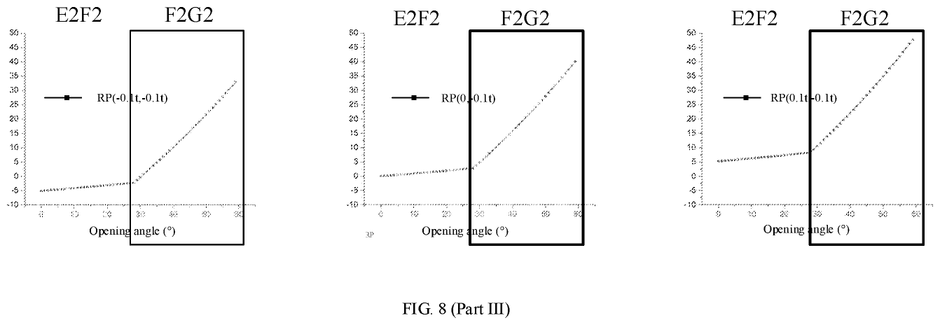

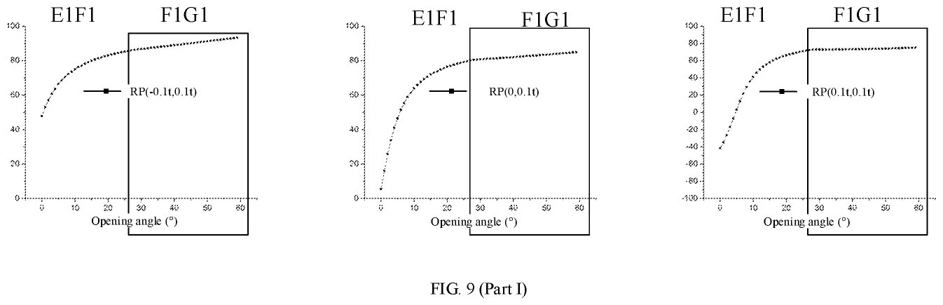

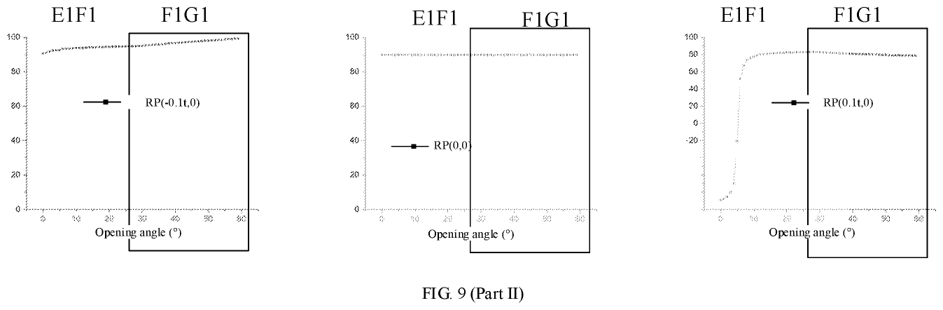

Referring to FIGS. 5 to 9, FIG. 5 is a schematic view of a motion trajectory of reference points in the case assembly shown in FIG. 1, FIG. 6 is a schematic view of a selection range of an inner reference point in the case assembly shown in FIG. 1, FIG. 7 is a schematic view of a selection range of an outer reference point in the case assembly shown in FIG. 1, FIG. 8 is a schematic view of an angle of a tangent direction of a trajectory of an inner reference point in the case assembly shown in FIG. 1, and FIG. 9 is a schematic view of an angle of a tangent direction of a trajectory of an outer reference point in the case assembly shown in FIG. 1.

In the present embodiment, an inner reference point R2 and an outer reference point R1 are defined. The outer reference point R1 is located adjacent to the outer edge 121, and the inner reference point R2 is located adjacent to the inner edge 122. A third reference plane Z is hereby defined, which is parallel to the first reference plane X, and a contour of the outer edge 121 is located on the third reference plane Z when in the closed state.

Specifically, a perpendicular distance from the inner reference point R2 to the second reference plane Y and a perpendicular distance from the inner reference point R2 to the first reference plane X are each less than or equal to 0.1t. The inner reference point R2 is selected in a rectangular region centered on the inner edge 122 with a side length of 0.2t.

Similarly, a perpendicular distance from the outer reference point R1 to the second reference plane Y and a perpendicular distance from the outer reference point R1 to the third reference plane Z are each less than or equal to 0.1t. The outer reference point R1 is selected in a rectangular region centered on the outer edge 121 with a side length of 0.2t.

The outer reference point R1 may be selected on the outer edge 121, and the inner reference point R2 may be selected on the inner edge 122.

The motion trajectory design ideas of the inner reference point R2 and the outer reference point R1 are also based on the above trajectory design ideas of the inner edge 122 and the outer edge 121. During the process of the door 12, under the action of the hinge assembly 13, moving from the closed state relative to the case 11 to an opened state at the first opening angle, the inner reference point R2 moves along the first inner-reference-point trajectory E2F2 toward the side of the second reference plane Y toward the opening, and the outer reference point R1 moves along the first outer-reference-point trajectory E1F1 toward the first reference plane X.

Characteristics of the first inner-reference-point trajectory E2F2 may be all similar to those of the first inner-edge trajectory A2B2, and characteristics of the first outer-reference-point trajectory E1F1 may be all similar to those of the first outer-edge trajectory A1B1. The tangent directions of the first inner-reference-point trajectory E2F2 and the second outer-reference-point trajectory E1F1 are specified below.

Referring to FIGS. 6 and 8, a coordinate system is established with any point on the inner edge 122 of the door 12 when in the closed state as an origin, with a straight line passing through the origin and located on the first reference plane X and perpendicular to the second reference plane Y as an x-axis, and with a straight line passing through the origin and located on the second reference plane Y and perpendicular to the first reference plane X as a y-axis. The inner reference points R2 are taken as (−0.1t,0.1t) (0,0.1t), (0.1t,0.1t), (−0.1t,0), (0,0), (0.1t,0), (−0.1t,−0.1t), (0,−0.1t), (0,−0.1t), (0.1t,0.1t), respectively, and are ordered from left to right on FIG. 8 beginning from the first row corresponding to the first inner-reference-point trajectory E2F2.

As can be seen from the figure, the tangent direction of the first inner-reference-point trajectory E2F2 is set along the first reference plane X, or is set inclined relative to the first reference plane X at a fifth angle of less than or equal to 10 degrees.

Further, during the process of the door 12 moving from the closed state to the opened state at the first opening angle, the fifth angle may remain unchanged or monotonically varies in a straight-line form, with a difference between a maximum value and a minimum value of the fifth angle being less than 5 degrees.

Referring to FIGS. 7 and 9, a coordinate system is established with any point on the outer edge 121 of the door 12 when in the closed state as an origin, with a line passing through the origin and located on the third reference plane Z and perpendicular to the second reference plane Y as an x-axis, and with a line passing through the origin and located on the second reference plane Y and perpendicular to the third reference plane Z as a y-axis. The outer reference points R1 are taken as (−0.1t,0.1t), (0,0.1t), (0.1t,0.1t), (−0.1t,0), (0,0), (0.1t,0), (−0.1t,−0.1t), (0,−0.1t), (0,−0.1t), (0.1t,0.1t), respectively, and are ordered from left to right on FIG. 9 beginning from the first row corresponding to the first outer-reference-point trajectory E1F1.

As can be seen from the figure, the tangent direction of the first outer-reference-point trajectory E1F1 is set perpendicular to the first reference plane X, or is set inclined relative to the first reference plane X at a sixth angle gradually approaching 90 degrees.

Further, the ratio of the lengths of the first inner-reference-point trajectory E2F2 and the first outer-reference-point trajectory E1F1 is 3.5 to 4.5.

For ease of design, in specific embodiments, the first inner-reference-point trajectory E2F2 may be a straight line and the first outer-reference-point trajectory E1F1 may be a straight line. Based on a selected position of the inner reference point R2, the first inner-reference-point trajectory E2F2 may be parallel to the first reference plane X or along the first reference plane X; and based on a selected position of the outer reference point R1, the first outer-reference-point trajectory may be parallel to the second reference plane Y or along the second reference plane Y. In this way, the tangent direction of the first outer-reference-point trajectory E1F1 is perpendicular to the first reference plane X, and the tangent direction of the first inner-reference-point trajectory E2F2 is set along the first reference plane X.

Similarly, corresponding to the inner edge 122 and the outer edge 121, both the outer reference point R1 and the inner reference point R2 may each have a second trajectory and a third trajectory. A second inner-reference-point trajectory F2G2 may have characteristics similar to the second inner-edge trajectory B2C2, and a second outer-reference-point trajectory F1G1 may have characteristics similar to the second outer-edge trajectory B1C1; a third inner-reference-point trajectory G2H2 may have characteristics similar to the third inner-edge trajectory C2D2, and a third outer-reference-point trajectory G1H1 may have characteristics similar to the third outer-edge trajectory C1D1.

The tangent directions of the second inner-reference-point trajectory F2G2 and the second outer-reference-point trajectory F1G1 are specified below.

Referring to FIGS. 6 and 8, a coordinate system is established with any point on the inner edge 122 of the door 12 when in the closed state as an origin, with a straight line passing through the origin and located on the first reference plane X and perpendicular to the second reference plane Y as an x-axis, and with a straight line passing through the origin and located on the second reference plane Y and perpendicular to the first reference plane X as a y-axis. The inner reference points R2 are taken as (−0.1t,0.1t), (0,0.1t), (0.1t,0.1t), (−0.1t,0), (0,0), (0.1t,0), (−0.1t,−0.1t), (0,−0.1t), (0,−0.1t), (0.1t,0.1t), respectively, and are ordered from left to right on FIG. 8 beginning from the first row corresponding to the second inner-reference-point trajectory F2G2.

As can be seen from the figure, a seventh angle between the tangent direction of the second inner-reference-point trajectory F2G2 and the first reference plane X gradually increases, and a change in angle of the seventh angle corresponding to each unit of opening of the door 12 gradually increases.

Further, a difference between a maximum value and a minimum value of the seventh angle is greater than or equal to 35 degrees.

Referring to FIGS. 7 and 9, a coordinate system is established with any point on the outer edge 121 of the door 12 when in the closed state as an origin, with a line passing through the origin and located on the third reference plane Z and perpendicular to the second reference plane Y as an x-axis, and with a line passing through the origin and located on the second reference plane Y and perpendicular to the third reference plane Z as a y-axis. The outer reference points R1 are taken as (−0.1 t,0.1t), (0,0.1t), (0.1t,0.1t), (−0.1t,0), (0,0), (0.1t,0), (−0.1t,−0.1t), (0,−0.1t), (0,−0.1t), (0.1t,0.1t), respectively, and are ordered from left to right on FIG. 9 beginning from the first row corresponding to the second outer-reference-point trajectory F1G1.

As can be seen from the figure, the tangent direction of the second outer-reference-point trajectory F1G1 is set perpendicular to the first reference plane X, or is set inclined relative to the first reference plane X at an eighth angle between 70 degrees and 110 degrees.

Further, during the process of the door 12 moving from the opened state at the first opening angle to the opened state at the second opening angle, the eighth angle may remain unchanged or monotonically varies in a straight-line form, with a difference between a maximum value and a minimum value of the eighth angle being less than or equal to 10 degrees.

Under the action of the hinge assembly 13, during the process of the door 12 moving from the opened state at the first opening angle to the opened state at the second opening angle relative to the case 11, the inner reference point R2 moves along the second inner-reference-point trajectory F2G2 toward the side of the second reference plane Y toward the opening and the side of the first reference plane X back to the opening, and the outer reference point R1 moves along the second outer-reference-point trajectory F1G1 toward the first reference plane X.

For ease of design, in specific embodiments, the second outer-reference-point trajectory F1G1 may be a straight line, and may be along the second reference plane Y or parallel to the second reference plane Y. The second inner-reference-point trajectory F2G2 may be set such that a motion distance of the outer reference point R1 on the second outer-reference-point trajectory F1G1 and a rotation angle of the door 12 satisfy the following equation.

$$θ1 = \frac{t 1}{t} θ$$

where θ1 is the rotation angle, θ is a preset angle of 100 degrees-113 degrees, and t1 is the motion distance.

Further, the present disclosure also mitigates the problem of the door compressing the case and exceeding the side of the case assembly by limiting a motion trajectory of a motion instantaneous center of the door. The relative motion of the door and the case can be converted into the motion of the instantaneous center of the door. By designing the motion trajectory of the instantaneous center, the relative motion relationship between the door and the case may be limited, such that the door may not excessively compress the doorway and not excessively exceed the side of the case assembly. Based on above, after designing the motion trajectory of the instantaneous center, a motion trajectory of a fixed point on the case or the door may be determined according to the motion trajectory of the instantaneous center, and the hinge assembly may thus be designed by inverse deduction according to the motion trajectory of the fixed point. That is, the hinge assemblies that can realize the motion trajectory of the motion instantaneous center and the motion trajectory of the edge in the present disclosure is within the scope of the present disclosure.

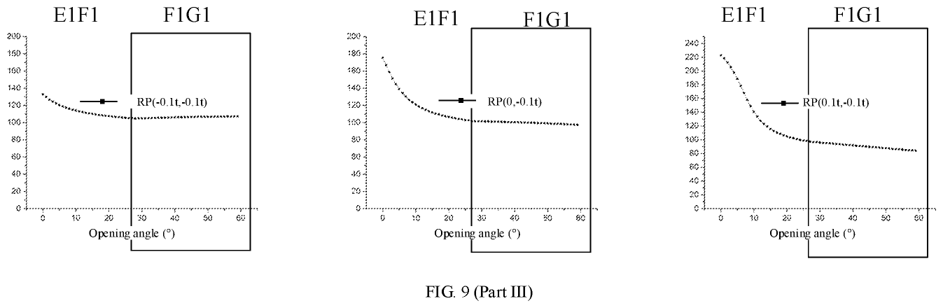

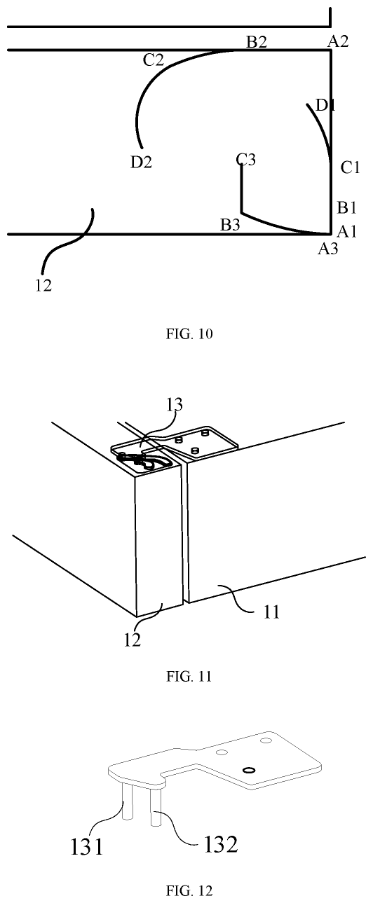

A third implementation is designed from another angle compared with the first implementation, i.e., the motion trajectory of the motion instantaneous center of the door, and therefore the accompanying drawings and reference numerals in the first implementation are continued to be used. Referring specifically to FIG. 10, FIG. 10 is a schematic view of a motion-instantaneous-center trajectory of a motion instantaneous center of a door in the case assembly shown in FIG. 1 according to a third implementation of the present disclosure.

In the present embodiment, the motion trajectory of the motion instantaneous center of the door 12 is limited. Specifically, the motion instantaneous center starts from the outer edge 121 along a first motion-instantaneous-center trajectory A3B3 toward the first reference plane X and simultaneously toward the side of the second reference plane Y toward the opening, thereby ensuring that the door 12 may not excessively compress the case 11 and not excessively exceed the side of the case 11.

The relevant setting of the motion trajectory of the motion instantaneous center of the door 12 determine the extent to which the inner edge 122 can compress the case 11 and the extent to which the outer edge 121 can exceed the side of the case assembly. In practice, it is permissible to allow the inner edge 122 to compress the case 11 to a certain extent. For example, when the case 11 is arranged with a deformable door seal, and the compress to a certain extent, applied by the inner edge 122 to the case 11, may be ignored. Similarly, it is permissible to allow the outer edge to exceed the side of the case assembly 100 by a certain degree. For example, for an embedded use of the case assembly, a gap exists between the case 11 and an embedding wall, and the gap allows the outer edge 121 to exceed the side of the case 11 by a certain extent.

It should be noted that in rigid-body planar motion, as long as the angular velocity ω of any cross-sectional figure S (or an extension thereof) on the rigid body parallel to a fixed plane is not zero at any instant, there must be a point P′, called an instantaneous center of velocity, at which the velocity is zero. At the instant, in terms of velocity distribution, the sectional figure (or an extension thereof) appears to be rotating only about a point P on the fixed plane coinciding with P′, the point P being called an instantaneous center of rotation. The motion instantaneous center in the present embodiment may be the instantaneous center of rotation or the instantaneous center of velocity of the door 12.

Further, an angle between a perpendicular line connecting the motion instantaneous center and the inner edge 122 and the first reference plane X is between 85 and 95 degrees. Within this range, it may be ensured that the first inner-edge trajectory A2B2 of the inner edge 122 moves toward the side of the second reference plane Y toward the opening and does not excessively compress the case 11. A maximum value and a minimum value of the angle between the perpendicular line connecting the motion instantaneous center and the inner edge 122 and the first reference plane X during the opening of the door are specifically defined as 95 degrees and 85 degrees, respectively, which may ensure that the door 12 may not excessively compress the case 11

Similarly, an angle between a perpendicular line connecting the motion instantaneous center and the outer edge 121 and the second reference plane Y is between 85 and 95 degrees. Within this range, it may be ensured that the first outer-edge trajectory A1B1 of the outer edge 122 moves toward the first reference plane X and does not excessively exceed the side of the case 11. A maximum value and a minimum value of the angle between the perpendicular line connecting the motion instantaneous center and the outer edge 121 and the second reference plane Y during the opening of the door are specifically defined as 95 degrees and 85 degrees, respectively, which may ensure that the door 12 may not excessively exceed the side of the case 11.

In some embodiments, the perpendicular line connecting the motion instantaneous center and the inner edge 122 is perpendicular to the first reference plane X, and during the opening process of the door 12 to the first opening angle, the first inner-edge trajectory A2B2 of the inner edge 122 is in a straight line and is parallel to the first reference plane X. The perpendicular line connecting the motion instantaneous center and the outer edge 121 is perpendicular to the second reference plane Y, and during the opening process of the door 12 to the first opening angle, the first outer-edge trajectory A1B1 of the outer edge 121 is in a straight line and parallel to the second reference plane Y. The present embodiment ensures that the edges are able to move smoothly by limiting the positional relationships of the motion instantaneous center with the inner edge 122 and the outer edge 121, thereby ensuring that the door 12 does not compress the case 11 and not exceed the side of the case 11.

In some embodiments, during the opening process of the door 12 to the first opening angle, the first motion-instantaneous-center trajectory A3B3 of the motion instantaneous center of the door 12 is in the form of an arc, a circle center of the arc is located at the midpoint of a perpendicular line connecting the inner edge 122 and the outer edge 121, and the diameter of the arc is a perpendicular distance between the inner edge 122 and the outer edge 121. When the motion instantaneous center of the door 12 moves along the first motion-instantaneous-center trajectory A3B3, the first inner-edge trajectory A2B2 of the inner edge 122 is in a straight line and parallel to the first reference plane X, and the first outer-edge trajectory A1B1 of the outer edge 121 is straight and parallel to the second reference plane Y. The present embodiment ensures that the edges are able to move smoothly by limiting the first motion-instantaneous-center trajectory of the motion instant center, thereby ensuring that the door 12 does not compress the case 11 and not exceed the side of the case 11.

Further, an angle between a line connecting the motion instantaneous center and the circle center and a line connecting the circle center and a start point of the first motion-instantaneous-center trajectory A3B3 is equal to an actual opening angle of the door 12 relative to the case 11. The movement of the motion instantaneous center varies regularly with the first opening angle of the door 12, and the process of the door 12 opening to the first opening angle is overall smooth, avoiding the situation of sliding jam and ensuring that the door 12 does not compress the case 11 and not exceed the side of the case 11. Specifically, the first opening angle is between 25 degrees and 31 degrees; for example, the first opening angle may be 25 degrees, 28 degrees, 30 degrees, or 31 degrees. Within the first opening angle, it may be ensured that the door 12 does not compress the case 11 and not exceed the side of the case 11.

Overall, in the present embodiment, during the process of the door 12, under the action of the hinge assembly 13, moving from the closed state relative to the case 11 to the opened state at the first opening angle, the motion instantaneous center of the door 12 starts from the outer edge 121 and moves along the first motion-instantaneous-center trajectory A3B3 toward the first reference plane X, and simultaneously toward the side of the second reference plane Y toward the opening. The first motion-instantaneous-center trajectory A3B3 has certain characteristics, and the door 12 moves according to the first motion-instantaneous-center trajectory A3B3, so as to attenuate or even avoid the door 12 from compressing the case 11 and from exceeding the side of the case 11.

That is, during the opening of the door 12 to the first opening angle, the inner edge 122 of the door 12 does not compress the case 11 and does not move excessively away from the case 11, while the outer edge 121 does not exceed the side of the case assembly 100 and does not move excessively toward the side of the second reference plane Y toward the opening. The above design allows the door 12 to be opened without significant displacement, and the movement of the door 12 is more stable.

In the present embodiment, when the motion instantaneous center of the door 12 moves along the first motion-instantaneous-center trajectory until the door 12 is opened at 90 degrees, the door 12 may not be able to be further opened at a greater angle, and a maximum opening angle of the door 12 is generally required to be greater than 90 degrees. Therefore, after the motion instantaneous center of the door 12 moves along the first inner motion-instantaneous-center trajectory until the door 12 is opened at an angle less than 90 degrees, the motion instantaneous center may move along another motion trajectory such that the door 12 may be further opened at an angle more than 90 degrees.

As mentioned before, the door 12 may move along a different trajectory after being opened at the first opening angle. In the present embodiment, during the process of the door 12, under the action of the hinge assembly 13, moving from the opened state at the first opening angle to the opened state at the second opening angle relative to the case 11, the motion instantaneous center moves along a second motion-instantaneous-center trajectory B3C3 toward the first reference plane X. An angle between a tangent direction of the second motion-instantaneous-center trajectory B3C3 and the first reference plane X is between 85 degrees and 95 degrees.

Based on the above characteristics of the trajectories, during the process of the door 12 moving from the opened state at the first opening angle to the opened state at the second opening angle, the door 12 may not compress the case 11 or excessively exceed the side of the case 11, allowing room for the door 12 to be opened at a greater angle.

The motion instantaneous center moves along the second motion-instantaneous-center trajectory B3C3 toward the first reference plane X, and the tangent direction of the second motion-instantaneous-center trajectory B3C3 is at an angle between 85 degrees and 95 degrees relative to the first reference plane X. Within this range, since the motion instantaneous center is always located on a side of the outer edge 121 back to the second reference plane Y, it may be ensured that the outer edge 122 does not excessively exceed the side of the case 11. Since the instantaneous motion center is always located on the side of the inner edge 122 back to the first reference plane X, it may be ensured that the first inner-edge trajectory A2B2 of the inner edge 122 moves toward the side of the second reference plane Y toward the opening and does not excessively compress the case 11.

Further, the second motion-instantaneous-center trajectory B3C3 is in a straight line and is set perpendicular to the first reference plane X. During the process of the door 12 moving from the opened state at the first opening angle to the opened state at the second opening angle, the second outer-edge trajectory B1C1 of the outer edge 121 is a straight line, and the second outer-edge trajectory B1C1 is set parallel to the second reference plane Y, ensuring that the outer edge 121 does not excessively exceed the side of the case 11; the inner edge 122 moves away from the first reference plane X, ensuring that the door 12 does not excessively compress the case 11. The end point C2 of the second inner-edge trajectory B2C2 is located on the side of the first reference plane X back to the opening, allowing room for the door 12 to be opened at a greater angle. Moreover, the second motion-instantaneous-center trajectory B3C3 of the motion instantaneous center varies regularly with the second opening angle of the door 12, and the process of the door 12 moving from the opened state at the first opening angle to the opened state at the second opening angle is overall smooth, avoiding the situation of sliding jam.

Further, during the process of the door 12 moving from the opened state at the first opening angle to the opened state at the second opening angle, the angle between the perpendicular line connecting the motion instantaneous center and the outer edge 121 and the second reference plane Y is between 85 degrees and 95 degrees. Within this range, it may be ensured that the second outer-edge trajectory B1C1 of the outer edge 122 moves toward the first reference plane X and does not excessively exceed the side of the case 11. A maximum value and a minimum value of the angle between the perpendicular line connecting the motion instantaneous center and the outer edge 121 and the second reference plane Y during the opening of the door are specifically defined as 95 degrees and 85 degrees, respectively, which may ensure that the door 12 may not excessively exceed the side of the case 11. When the perpendicular line connecting the motion instantaneous center and the outer edge 121 is perpendicular to the second reference plane Y, i.e., when the angle between the perpendicular line connecting the motion instantaneous center and the outer edge 121 and the second reference plane Y is 90 degrees, the second outer-edge trajectory B1C1 of the outer edge 121 is a straight line and perpendicular to the first reference plane X during the process of the motion instantaneous center of the door 12 moving along the second motion-instantaneous-center trajectory B3C3, ensuring that the door 12 may not excessively exceed the side of the case 11.

In addition, during the process of the door 12 moving from the opened state at the first opening angle to the opened state at the second opening angle, the perpendicular distance from the inner edge 122 to the motion instantaneous center gradually decreases, such that the radius of curvature of the second inner-edge trajectory B2C2 of the inner edge 122 gradually decreases, and the end point C2 is located on the side of the first reference plane X back to the opening. Therefore, there is room for the door 12 to be opened to a greater angle, and it may be ensured that the door 12 may not compress the case.

Based on the above characteristics of the trajectories, during the process of the door 12 moving from the opened state at the first opening angle to the opened state at the second opening angle, the door 12 may not compress the case 11 or excessively exceed the side of the case 11.

Specifically, the second opening angle is between 57 degrees and 60 degrees, and the second opening angle may be 57 degrees, 58 degrees, 59 degrees, or 60 degrees, and the like. Within the second opening angle, it may be ensured that the door 12 may not compress the case 11 or exceed the side of the case 11.

Under the action of the hinge assembly 13, the door 12 may continue to be opened from the second opening angle to a third opening angle relative to the case 11. During the process of the door 12 moving from the opened state at the second opening angle to an opened state at the third opening angle, the motion instantaneous center may remain unchanged, and the door 12 is rotated around the motion instantaneous center as a whole. The motion trajectory corresponds to a greater opening angle of the door 12.

As mentioned above, during the process of the door 12 moving from the opened state at the second opening angle to the opened state at the third opening angle relative to the case 11, the motion instantaneous center remains unchanged at the end point of the second motion-instantaneous-center trajectory, and the third inner-edge trajectory C2D2 of the inner edge 122 and the third outer-edge trajectory C1D1 of the outer edge 121 are specified to be concentrically disposed arcs.

Based on the above characteristics of the trajectories, during the process of the door 12 moving from the opened state at the second opening angle to the opened state at the third opening angle, the door 12 may not compress the case 11 or excessively exceed the side of the case 11.

After the motion of the motion instantaneous center of the door 12 along the first motion-instantaneous-center trajectory A3B3, in order to realize a greater opening angle, the motion instantaneous center may move directly along a third motion-instantaneous-center trajectory with the end point of the first motion-instantaneous-center trajectory A3B3 as a start, thereby solving the problem of compressing the case 11 and exceeding the side of the case 11.

However, after designing the hinge assembly 13 based on the first motion-instantaneous-center trajectory A3B3 and the third motion-instantaneous-center trajectory, the door 12 may be prone to shaking during the rotation process of the door 12 under the action of the hinge assembly 13. In order to further optimize and solve the problem of shaking, the second motion-instantaneous-center trajectory B3C3 is added between the first motion-instantaneous-center trajectory A3B3 and the third motion-instantaneous-center trajectory, so as to make the motion process of the door 12 more stable and smoother.

Starting from the design of the motion trajectory of the edge of the door 12, based on the design principle of relative motion, a variety of hinge assembly structures may be designed. As shown in FIGS. 11-13, FIG. 11 is a structural schematic view of a case assembly according to a fourth implementation of the present disclosure, FIG. 12 is a schematic view of a hinge shaft structure of a hinge assembly in the case assembly shown in FIG. 11, and FIG. 13 is a schematic view of a hinge slot structure of a hinge assembly in the case assembly shown in FIG. 11.

The fourth implementation specifies the structure of the hinge assembly as compared to the first implementation shown in FIG. 1, and therefore the reference numerals continue to follow those in the first implementation. The design of the hinge assembly 13 in the case assembly 100 of the present embodiment is to convert the motion trajectories of the edges of the door 12 into the motion trajectories of two fixed points on the door 12 or the case 11, and design the corresponding mechanical structure based on the motion trajectories of the two fixed points. The hinge assembly 13 includes a first guiding mechanism 135 and a second guiding mechanism 136 to realize the motion trajectories of the two fixed points, i.e., the two guiding mechanisms may cooperate to make the edges of the door 12 move along the predetermined trajectories.

Referring to FIGS. 11-13, the guiding mechanism is a slot-shaft cooperation structure. Obviously, the guiding mechanisms designed based on the motion trajectories may be linking rod structures, slot-shaft+linking rod structure, etc.

The hinge assembly 13 in the present embodiment is a dual-shaft and dual-slot design, and the two slots are defined on the door 12 and the two shafts are arranged on the case 11. Similarly, in other embodiments, the two slots may be defined on the case 11 and the two shafts are arranged on the door 12; or the door 12 is arranged with one shaft and one slot, and the case 11 is arranged with the other shaft and the other slot; or, as mentioned above, the slot-shaft structures on the door 12 and the case 11 may be converted into connecting rod structures, or shaft+track sliding structures, etc.

Specifically, the hinge assembly 13 of the present embodiment includes a first hinge shaft 131 and a second hinge shaft 132 arranged on the case 11, and a first hinge slot 133 and a second hinge slot 134 defined on the door 12. The first hinge shaft 131 is movable within the first hinge slot 133, and the first hinge shaft 131 and the first hinge slot 133 constitute the first guiding mechanism 135. The second hinge shaft 132 is movable within the second hinge slot 134, and the second hinge shaft 132 and the second hinge slot 134 constitute the second guiding mechanism 136. In this way, the motion trajectories of the edges of the door as shown in FIG. 3 are realized, which then solves the problems of the door 12 compressing the case 11 and exceeding the side of the case assembly 100.

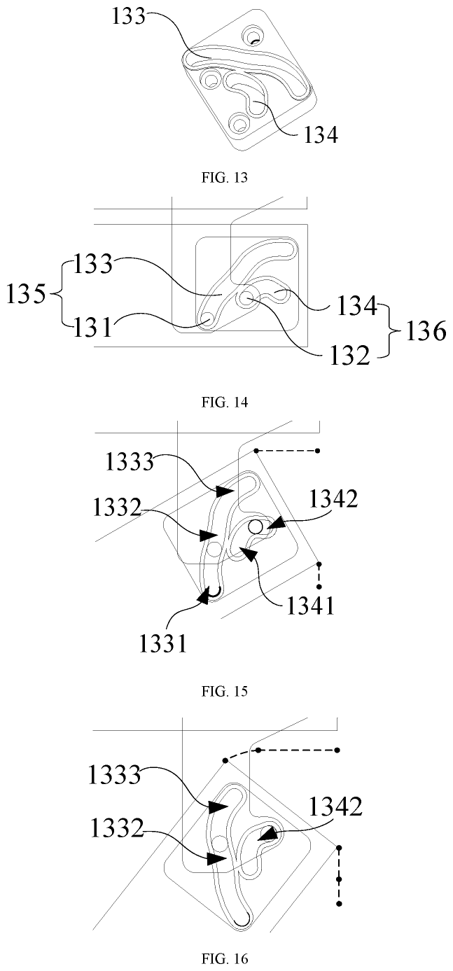

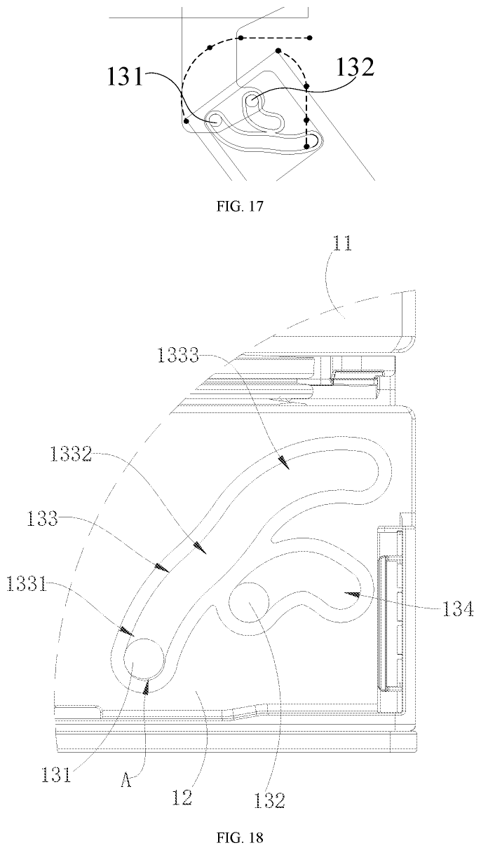

During the opening process of the door 12, a motion state of the hinge assembly 13 is illustrated in FIGS. 14-17, wherein FIG. 14 is a state schematic view of a hinge assembly in the case assembly shown in FIG. 11 when a door is in a closed state relative to a case, FIG. 15 is a state schematic view of a hinge assembly in the case assembly shown in FIG. 11 when a door is in an opened state relative to a case at a first opening angle, FIG. 16 is a state schematic view of a hinge assembly in the case assembly shown in FIG. 11 when a door is in an opened state relative to a case at a second opening angle, and FIG. 17 is a state schematic view of a hinge assembly in the case assembly shown in FIG. 11 when a door is in an opened state relative to a case at a third opening angle.

The first hinge slot 133 in the present embodiment includes a first slot segment 1331, a second slot segment 1332, and a third slot segment 1333; the second hinge slot 134 includes a fourth slot segment 1341 and a fifth slot segment 1342.

During the process of the door 12 moving from a closed state relative to the case 11 to an opened state at a first opening angle, the first hinge shaft 131 moves along the first slot section 1331 and the second hinge shaft 132 moves along the fourth slot section 1341, correspondingly realizing the first trajectories in FIG. 3.

During the process of the door 12 moving from the opened state at the first opening angle to an opened state at a second opening angle relative to the case 11, the first hinge shaft 131 moves along the second slot segment 1332 and the second hinge shaft 132 moves along the fifth slot segment 1342, correspondingly realizing the second trajectories in FIG. 3.

During the process of the door 12 moving from the opened state at the second opening angle to an opened state at a third opening angle relative to the case 11, the first hinge shaft 131 moves along the third slot segment 1333 and the second hinge shaft 132 does not undergo a positional change at a bottom end of the fifth slot segment 1342, correspondingly realizing the third trajectories in FIG. 3.

The first hinge slot 133 and the second hinge slot 134 have a tendency to separate from each other in a direction toward the first reference plane. The first slot segment 1331 is farther away from the second reference plane Y compared to the fourth slot segment 1341 and extends toward the second reference plane Y and the first reference plane X to form the second slot segment 1332 and the third slot segment 1333. An angle between a tangent direction of the first slot segment 1331 and the first reference plane X is greater than an angle between a tangent direction of the fourth slot segment 1341 and the first reference plane X.

The design of the hinge assembly 13 in the present embodiment allows the door 12 to be opened stably and smoothly relative to the case 11, without compressing the case 11 or exceeding the side of the case assembly 100, which facilitates embedded use.

In some embodiments, when the door body 12, under the action of the hinge assembly 13, is opened from the closed state relative to the case 11 to the first opening angle and opened from the first opening angle relative to the case 11 to the second opening angle, the outer edge 121 moves along the first outer-edge trajectory and the second outer-edge trajectory, respectively, toward the first reference plane; at least part of the first outer-edge trajectory and at least part of the second outer-edge trajectory have a radius of curvature that is greater than or equal to 5t, and the distance of the first outer-edge trajectory and the second outer-edge trajectory exceeding the side of the second reference plane back to the opening is less than or equal to the first predetermined distance; when the door 12 is opened from the second opening angle relative to the case to the third opening angle under the action of the hinge assembly 13, the outer edge 121 moves along the third outer-edge trajectory to the side of the second reference plane toward the opening, and the third outer-edge trajectory is an arc with a radius of curvature of 0.45t-0.55t, and the circle center of the third outer-edge trajectory is located in the door.

In the actual processing of the product, a radius of curvature of some of the first outer-edge trajectories may be less than 5t and a radius of curvature of some of the first inner-edge trajectories may be less than 100t, due to manufacturing tolerances or the like.

In some embodiments, in the actual processing of the product, referring to FIG. 18, an accommodation slot A communicating with the first hinge slot 133 may be defined extending from an end of the first hinge slot 133 away from the inner edge, i.e., the end of the first slot segment 1331 back from the second slot segment 1332 defines the accommodation slot A communicating with the first slot segment 1331, so as to allow a gap between the first hinge shaft 131 and a wall of the end of the first slot segment 1331 back from the second slot segment 1332 when the door 12 is in a normal closed state.

During a special closing process of the door 12, such as when the door is closed with a high closing force, the accommodation slot A may prevent the door 12 from being popped open by contact between the first hinge shaft 131 and the wall of the end of the first slot segment 1331 back from the second slot segment 1332.

In this special closed state, a part of the first hinge shaft 131 may be jammed into the accommodation slot A. The door 12 needs to move from the accommodation slot A to the first slot segment 1331 first during the opening process from the closed state to the first opening angle, such that the radius of curvature of the first outer-edge trajectory may be less than 5t and the radius of curvature of the first outer-edge trajectory may be less than 100t. While in the normal closed state of the door 12, the first hinge shaft 131 is generally not located within the accommodation slot A.

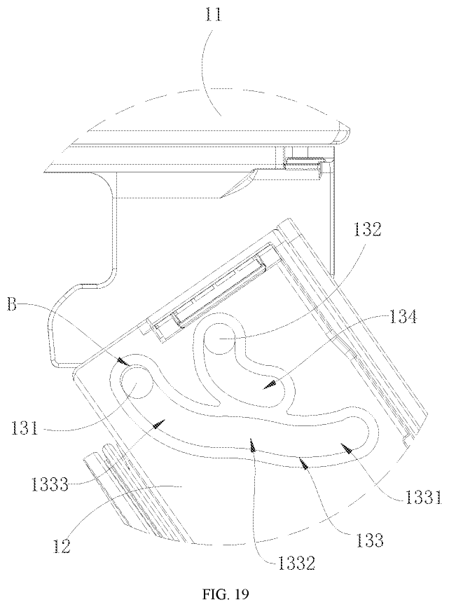

In some embodiments, in the actual processing of the product, referring to FIG. 19, an accommodation slot B communicating with the first hinge slot 133 may be defined extending from an end of the first hinge slot 133 near the inner edge, i.e., the end of the third slot segment 1333 back from the second slot segment 1332 defines the accommodation slot B communicating with the third slot segment 1333, so as to allow a gap between the first hinge shaft 131 and a wall of the end of the third slot segment 1333 back from the second slot segment 1332 when the door 12 is in a normal closed state.

During a special opening process of the door 12, such as when the door is opened with a high closing force, the door 12, on the basis of normal opening, will continue to move back away from the case, such that first hinge shaft 131 continues to move to the accommodation slot B, forming an avoidance and cushioning of the first hinge shaft 131, thereby reducing the vibration of the refrigeration device and improving the smoothness when closing the door.

In this special opened state, the door 12 needs to move from the accommodation slot B to the third slot segment 1333 first during the closing process from the second opening angle to the third opening angle, such that the radius of curvature of the first outer prong trajectory may be less than 5t, and the radius of curvature of the first inner-edge trajectory may be less than 100t. While in the normal opened state of the door 12, the first hinge shaft 131 is generally not located within the accommodation slot B.

In some embodiments, both ends of the first hinge slot 133 may be improved as described above.

In summary, for the present disclosure, corresponding to the different trajectories of the edges of the door, different hinge assemblies may be designed to reduce the problems of door compressing the case and exceeding the side of the case assembly when the door is opened. The design of the above case assembly may be applied to products such as refrigerators, cabinets and other products that have a door and have problems of compressing the case and interference when exceeding the case assembly.

The present disclosure further proposes a refrigeration device, the refrigeration device including the above case assembly 100, i.e., with the door 12, the case 11, and the hinge assembly 13 between the door 12 and the case 11. The refrigeration device may be a refrigerator, a freezer, a wine cooler, a freshness cabinet, etc.

The foregoing is only some embodiments of the present disclosure and is not intended to limit the scope of the present disclosure, and any equivalent structure or equivalent process transformation utilizing the contents of the specification and the accompanying drawings of the present disclosure, or directly or indirectly utilized in other related technical fields, are all reasonably included in the scope of the present disclosure.

What is claimed is:

1. A case assembly, comprising:
a case, defining a holding space; wherein the holding space has an opening;
a door, configured to block the opening; and
a hinge assembly, arranged on a pivot side of the case and pivotally connected to the door and the case;
wherein the door has an outer edge and an inner edge on the pivot side; a first reference plane and a second reference plane are defined for the door; the first reference plane is parallel to a plane where the opening is located, and a contour of the inner edge is located on the first reference plane in a closed state; the second reference plane is perpendicular to the plane where the opening is located, and a contour of the outer edge is located on the second reference plane in the closed state; the first reference plane and the second reference plane remain stationary with respect to the case during a process of the door being opened relative to the case;
during a process of the door, under an action of the hinge assembly, moving from the closed state to an opened state at a first opening angle relative to the case, the outer edge moves toward the first reference plane along a first outer-edge trajectory; the first outer-edge trajectory has a radius of curvature greater than or equal to 5t, and a distance of the first outer-edge trajectory exceeding a side of the second reference plane back to the opening is less than or equal to a first predetermined distance;
during a process of the door, under the action of the hinge assembly, moving from the opened state at the first opening angle to an opened state at a second opening angle relative to the case, the outer edge moves along a second outer-edge trajectory toward the first reference plane; the second outer-edge trajectory has a radius of curvature greater than or equal to 5t, and a distance of the second outer-edge trajectory exceeding the side of the second reference plane back to the opening is less than or equal to the first predetermined distance; wherein the t is a thickness of the door;
during a process of the door, under the action of the hinge assembly, moving from the opened state at the second opening angle to an opened state at a third opening angle relative to the case, the outer edge moves along a third outer-edge trajectory toward a side of the second reference plane toward the opening; the third outer-edge trajectory is an arc having a radius of curvature of 0.45t-0.55t; a circle center of the third outer-edge trajectory is located in the door.

2. The case assembly according to claim 1, wherein the first opening angle is between 25 degrees and 31 degrees, the second opening angle is between 57 degrees and 60 degrees, and the third opening angle is between 122 degrees and 132 degrees.

3. The case assembly according to claim 1, wherein an end point of the first outer-edge trajectory is located on the second reference plane, or the end point of the first outer-edge trajectory is located on the side of the second reference plane toward the opening and a distance between the end point of the first outer-edge trajectory and the second reference plane is less than or equal to 0.135t.

4. The case assembly according to claim 2, wherein during the process of the door, under the action of the hinge assembly, moving from the closed state to the opened state at the first opening angle relative to the case, the inner edge moves toward the side of the second reference plane toward the opening along a first inner-edge trajectory; wherein the first inner-edge trajectory has a radius of curvature greater than or equal to 100t, and a distance of the first inner-edge trajectory exceeding a side of the first reference plane toward the opening is less than or equal to a second predetermined distance;
during the process of the door, under the action of the hinge assembly, moving from the opened state at the first opening angle to the opened state at the second opening angle relative to the case, the inner edge moves along a second inner-edge trajectory toward the side of the second reference plane toward the opening and a side of the first reference plane back to the opening; wherein a radius of curvature of the second inner-edge trajectory gradually decreases, an end point of the second inner-edge trajectory is located on the side of the first reference plane back to the opening, and a distance between the end point of the second inner-edge trajectory and the first reference plane is greater than or equal to 0.3t;
during the process of the door, under the action of the hinge assembly, moving from the opened state at the second opening angle to the opened state at the third opening angle relative to the case, the inner edge moves along a third inner-edge trajectory toward the side of the first reference plane back to the opening; wherein the third outer-edge trajectory and the third inner-edge trajectory are concentrically disposed arcs, the third inner-edge trajectory having a radius of curvature of 0.55t-0.67t.

5. The case assembly according to claim 4, wherein an end point of the first inner-edge trajectory is located on the first reference plane, or the end point of the first inner-edge trajectory is located on a side of the first reference plane back to the opening and a distance between the end point of the first inner-edge trajectory and the first reference plane is less than or equal to 0.058t.

6. The case assembly according to claim 4, wherein the first predetermined distance is between 0 mm and 4 mm, and the second predetermined distance is between 0 mm and 2 mm.

7. The case assembly according to claim 4, wherein a length of the first inner-edge trajectory is greater than a length of the first outer-edge trajectory, and a ratio of the length of the first inner-edge trajectory to the length of the first outer-edge trajectory is 3.5 to 4.5.

8. The case assembly according to claim 4, wherein a ratio of the radius of curvature of the third inner-edge trajectory to the radius of curvature of the third outer-edge trajectory is 1.22.

9. The case assembly according to claim 4, wherein a distance from the circle center to the first reference plane is 0.6t, and a distance from the circle center to the second reference plane is 0.5t.

10. The case assembly according to claim 1, wherein an outer reference point is defined for the door, and the outer reference point is located adjacent to the outer edge;
during the process of the door, under the action of the hinge assembly, moving from the closed state to the opened state at the first opening angle relative to the case, the outer reference point moves along a first outer-reference-point trajectory toward the first reference plane; the first outer-reference-point trajectory is a straight line;
during the process of the door, under the action of the hinge assembly, moving from the opened state at the first opening angle to the opened state at the second opening angle relative to the case, the outer reference point moves along a second outer-reference-point trajectory toward the first reference plane; the second outer-reference-point trajectory is a straight line.

11. The case assembly according to claim 10, wherein an inner reference point is further defined for the door; the inner reference point is located adjacent to the inner edge;
during the process of the door, under the action of the hinge assembly, moving from the closed state to the opened state at the first opening angle relative to the case, the inner reference point moves along a first inner-reference-point trajectory toward the side of the second reference plane toward the opening, and the first inner-reference-point trajectory is a straight line;
during the process of the door, under the action of the hinge assembly, moving from the opened state at the first opening angle to the opened state at the second opening angle relative to the case, the inner reference point moves along a second inner-reference-point trajectory toward the side of the second reference plane toward the opening and the side of the first reference plane back to the opening; the second inner-reference-point trajectory is set such that a motion distance of the outer reference point on the second outer-reference-point trajectory and a rotation angle of the door satisfy:
$$θ1 = \frac{t 1}{t} θ$$
where θ1 is the rotation angle, θ is a preset angle of 100 degrees-113 degrees, and t1 is the motion distance.

12. The case assembly according to claim 11, wherein a perpendicular distance from the inner reference point to the second reference plane and a perpendicular distance from the inner reference point to the first reference plane are each less than or equal to 0.1t;
a perpendicular distance from the outer reference point to the second reference plane and a perpendicular distance from the outer reference point to a third reference plane are each less than or equal to 0.1t; wherein the third reference plane is parallel to the first reference plane, and a contour of the outer edge is located on the third reference plane in the closed state.

13. The case assembly according to claim 12, wherein the outer reference point is located on the outer edge, and the inner reference point is located on the inner edge.

14. The case assembly according to claim 11, wherein the first inner-reference-point trajectory is parallel to the first reference plane or along the first reference plane, and the first outer-reference-point trajectory is parallel to the second reference plane or along the second reference plane; the second outer-reference-point trajectory is along the second reference plane or parallel to the second reference plane.

15. The case assembly according to claim 11, wherein a length of the first inner-reference-point trajectory is greater than a length of the first outer-reference-point trajectory, and a ratio of the length of the first inner-reference-point trajectory to the length of the first outer-reference-point trajectory is 3.5 to 4.5.

16. A case assembly, comprising:
a case, defining a holding space; wherein the holding space has an opening;
a door, configured to block the opening; and
a hinge assembly, arranged on a pivot side of the case and pivotally connected to the door and the case;
wherein the door has an outer edge and an inner edge on the pivot side; in condition of the door being in a closed state relative to the case, the inner edge is closer to the case compared to the outer edge; a first reference plane and a second reference plane are defined for the door; the first reference plane is parallel to a plane where the opening is located, and a contour of the inner edge is located on the first reference plane in the closed state; the second reference plane is perpendicular to the plane where the opening is located, and a contour of the outer edge is located on the second reference plane in the closed state;
during a process of the door, under an action of the hinge assembly, moving from the closed state to an opened state at a first opening angle relative to the case, the outer edge moves toward the first reference plane along a first outer-edge trajectory, and the inner edge moves toward a side of the second reference plane toward the opening along a first inner-edge trajectory;
wherein the first outer-edge trajectory has a radius of curvature greater than or equal to 5t, and a distance of the first outer-edge trajectory exceeding a side of the second reference plane back to the opening is less than or equal to a first predetermined distance; the first inner-edge trajectory has a radius of curvature greater than or equal to 100t, and a distance of the first inner-edge trajectory exceeding a side of the first reference plane toward the opening is less than or equal to a second predetermined distance; wherein the t is a thickness of the door.

17. The case assembly according to claim 16, wherein the first opening angle is between 25 degrees and 31 degrees, the first predetermined distance is 3 mm, and the second predetermined distance is 1.5 mm.

18. The case assembly according to claim 16, wherein an end point of the first inner-edge trajectory is located on the first reference plane, or the end point of the first inner-edge trajectory is located on a side of the first reference plane back to the opening and a distance between the end point of the first inner-edge trajectory and the first reference plane is less than or equal to 0.058t;
an end point of the first outer-edge trajectory is located on the second reference plane, or the end point of the first outer-edge trajectory is located on the side of the second reference plane toward the opening and a distance between the end point of the first outer-edge trajectory and the second reference plane is less than or equal to 0.135t.

19. The case assembly according to claim 16, wherein during a process of the door, under the action of the hinge assembly, moving from the opened state at the first opening angle to an opened state at a second opening angle relative to the case, the outer edge moves along a second outer-edge trajectory toward the first reference plane, and the inner edge moves along a second inner-edge trajectory toward the side of the second reference plane toward the opening and a side of the first reference plane back to the opening;
the second outer-edge trajectory has a radius of curvature greater than or equal to 5t, and a distance of the second outer-edge trajectory exceeding the side of the second reference plane back to the opening is less than or equal to the first predetermined distance; a radius of curvature of the second inner-edge trajectory gradually decreases.

20. A case assembly, comprising:
a case, defining a holding space; wherein the holding space has an opening;
a door, configured to block the opening; and
a hinge assembly, arranged on a pivot side of the case and pivotally connected to the door and the case;
wherein the door has an outer edge and an inner edge on the pivot side; a first reference plane and a second reference plane are defined for the door; the first reference plane is parallel to a plane where the opening is located, and a contour of the inner edge is located on the first reference plane in a closed state; the second reference plane is perpendicular to the plane where the opening is located, and a contour of the outer edge is located on the second reference plane in the closed state; the first reference plane and the second reference plane remain stationary with respect to the case during a process of the door being opened relative to the case;
during a process of the door, under an action of the hinge assembly, moving from the closed state to an opened state at a first opening angle relative to the case, the outer edge moves toward the first reference plane along a first outer-edge trajectory; a radius of curvature of at least part of the first outer-edge trajectory is greater than or equal to 5t, and a distance of the first outer-edge trajectory exceeding a side of the second reference plane back to the opening is less than or equal to a first predetermined distance;
during a process of the door, under the action of the hinge assembly, moving from the opened state at the first opening angle to an opened state at a second opening angle relative to the case, the outer edge moves along a second outer-edge trajectory toward the first reference plane; a radius of curvature of at least part of the second outer-edge trajectory is greater than or equal to 5t, and a distance of the second outer-edge trajectory exceeding the side of the second reference plane back to the opening is less than or equal to the first predetermined distance; wherein the t is a thickness of the door;
during a process of the door, under the action of the hinge assembly, moving from the opened state at the second opening angle to an opened state at a third opening angle relative to the case, the outer edge moves along a third outer-edge trajectory toward a side of the second reference plane toward the opening; the third outer-edge trajectory is an arc having a radius of curvature of 0.45t-0.55t; a circle center of the third outer-edge trajectory is located in the door.
